(19) United States
(12) Patent Application Publication
(10) Pub. No.: US 2026/0129481 A1
(43) Pub. Date: May 7, 2026

(54) CELLULAR NETWORK ARTIFICIAL INTELLIGENCE / MACHINE LEARNING-ASSISTED USER INTERACTION WORKFLOW ENHANCEMENT

(71) Applicant: AT&T Intellectual Property I, L.P., Atlanta, GA (US)

(72) Inventors: Xiaofeng Shi, Vernon, CT (US); Jia Wang, Bedminster, NJ (US); Amit Kumar Sheoran, Raritan, NJ (US); Mukesh Mantan, Irving, TX (US)

(73) Assignee: AT&T Intellectual Property I, L.P., Atlanta, GA (US)

(21) Appl. No.: 18/937,722

(22) Filed: Nov. 5, 2024

(51) Int. Cl. H04W 24/04; H04L 41/16; H04M 3/51; H04W 64/00

(52) U.S. Cl. CPC H04W 24/04; H04L 41/16; H04M 3/5183; H04W 64/006

(57) ABSTRACT

Aspects of the subject disclosure may include, for example, retrieving network performance data for a cellular network, wherein the retrieving network performance data comprises retrieving cell key performance indicator (KPI) data for selected cells of the cellular network and user equipment (UE) KPI data for a user device associated with a service issue in the cellular network, inferring, by a machine learning (ML) model, a category for a cause of the service issue, wherein the ML model receives at least a portion of the cell KPI data and the UE KPI data as input, and providing information about the category for the cause of the service issue to a service agent for resolution of the service issue before connecting a care call with a customer associated with the user device. Other embodiments are disclosed.

### FIELD OF THE DISCLOSURE

The subject disclosure relates to a machine learning-assisted service diagnosis and system and method for a next-generation cellular network.

### BACKGROUND

As the primary channel for users to report and resolve service issues, customer care has historically been a critical and resource-intensive aspect of operating cellular networks. A customer care agent of the network operator interfaces directly with a customer experiencing an issue. Inherent complexity in correlating network events with the service performance experienced by individual users has heretofore limited available solutions.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B. illustrates a conventional troubleshooting and resolution workflow for resolving a customer service issue in a cellular network such as the cellular network of FIG. 2A.

FIG. 2C is a functional block diagram illustrating an exemplary pre-diagnosis module for operation with an improved troubleshooting and resolution workflow for resolving customer service issues.

FIG. 2D depicts a block diagram of a machine learning module (ML module) for use in conjunction with the pre-diagnosis module of FIG. 2C, in accordance with various aspects described herein.

FIG. 2E illustrates candidate feature profiling methods for use with a machine learning model to profile a service quality history of a user equipment and its critical serving cells.

FIG. 2F illustrates root cause determination for service issues in a cellular network in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for inferring causes of customer-reported service issues in a cellular network based on network data and providing a recommended resolution accordingly. Other embodiments are described in the subject disclosure.

One or more aspects of the subject disclosure include receiving a care call from a user reporting a service issue in a cellular network, the cellular network including cells for providing communication services to user equipment, retrieving network performance data based on a user identification of the user, identifying network performance anomalies based on the network performance data, and identifying service degradation for a user device of the user based on the network performance data. Aspects of the subject disclosure further include correlating, in an artificial intelligence/machine learning (AI/ML) process, the network performance anomalies and the service degradation for the user, identifying a service issue category for the service issue based the AI/ML process, and reporting the service issue category to a care agent prior to connecting the care call between the user and the care agent.

One or more aspects of the subject disclosure include retrieving network performance data for a cellular network, wherein the retrieving the network performance data is responsive to receipt of user identification of a user associated with a user device, the user device associated with a service issue in the cellular network, identifying critical serving cells of the cellular network for the user device, identifying, for the critical serving cells, network performance anomalies, wherein the identifying the network performance anomalies is based on the network performance data, and identifying, for the user device of the user, service degradation, wherein the identifying the service degradation is based on the network performance data. Aspects of the subject disclosure further include combining anomaly information based on the network performance anomalies and service degradation information based on the service degradation, forming a cell profile, providing the cell profile as an input to a machine learning model, receiving, from the machine learning model, a service issue category for the service issue, and providing information about an identification of the service issue category to a care agent for resolution of the service issue.

One or more aspects of the subject disclosure include retrieving network performance data for a cellular network, wherein the retrieving network performance data comprises retrieving cell key performance indicator (KPI) data for selected cells of the cellular network and user equipment (UE) KPI data for a user device associated with a service issue in the cellular network, inferring, by a machine learning (ML) model, a category for a cause of the service issue, wherein the ML model receives at least a portion of the cell KPI data and the UE KPI data as input, and providing information about the category for the cause of the service issue to a service agent for resolution of the service issue before connecting a care call with a customer associated with the user device.

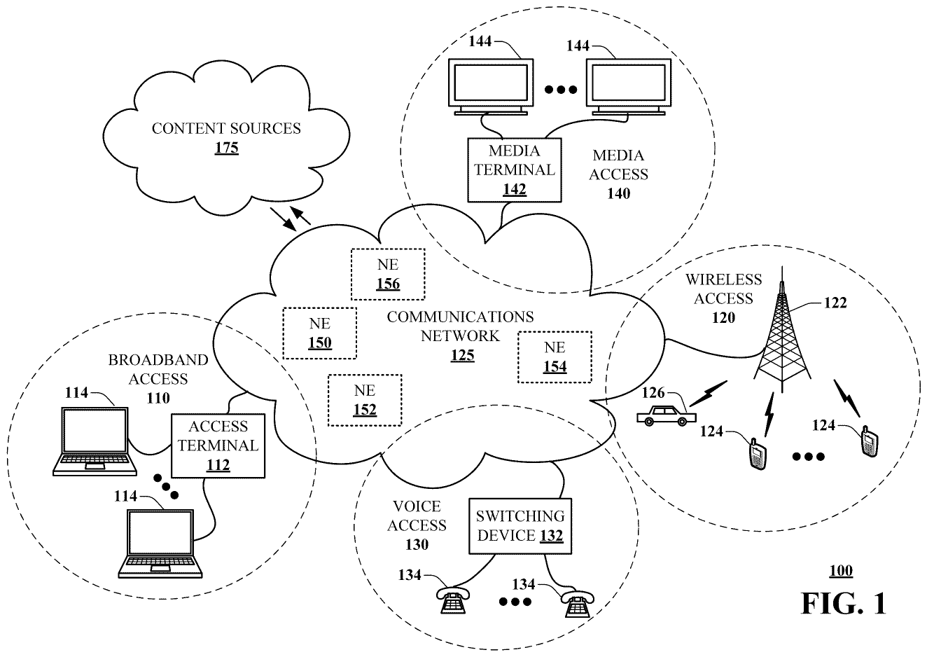

Referring now to FIG. 1, a block diagram is shown illustrating an example, non-limiting embodiment of a system 100 in accordance with various aspects described herein. For example, system 100 can facilitate in whole or in part retrieving network performance data for troubleshooting a service issue in a network, inferring a category for the root cause of the service issue using a machine learning model or artificial intelligence process, and providing information about the category of the root cause to a customer care agent for resolution of the service issue. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

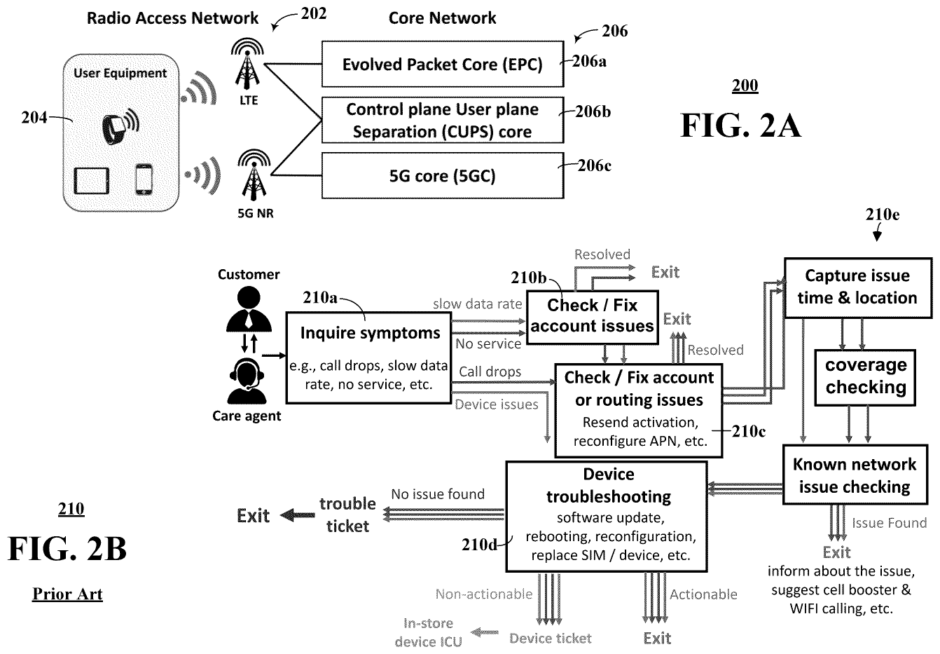

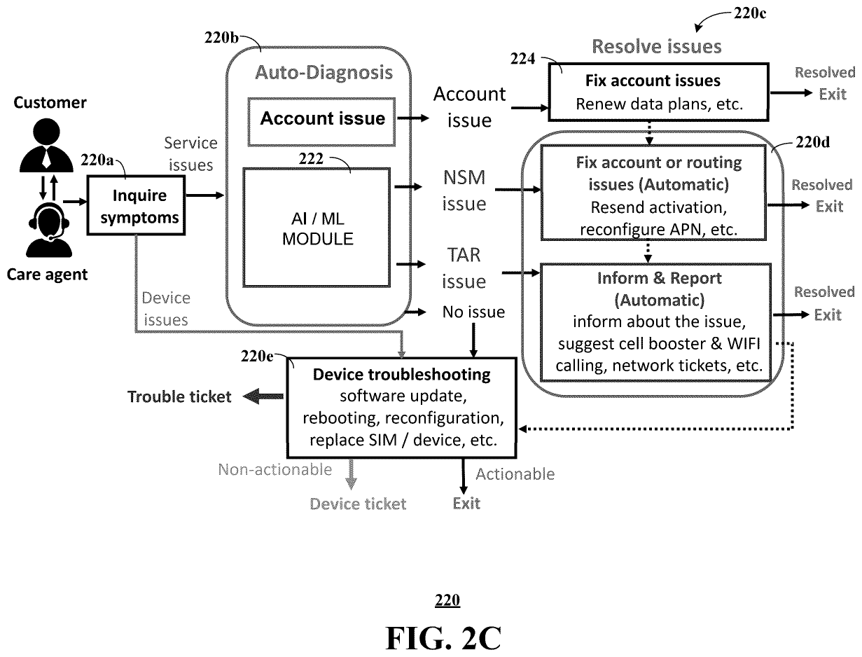

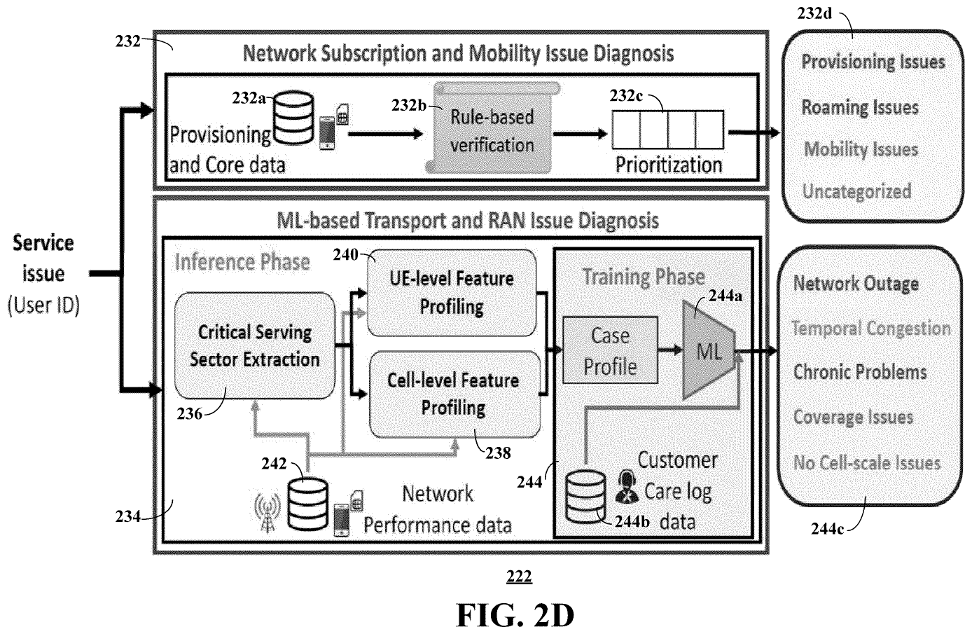

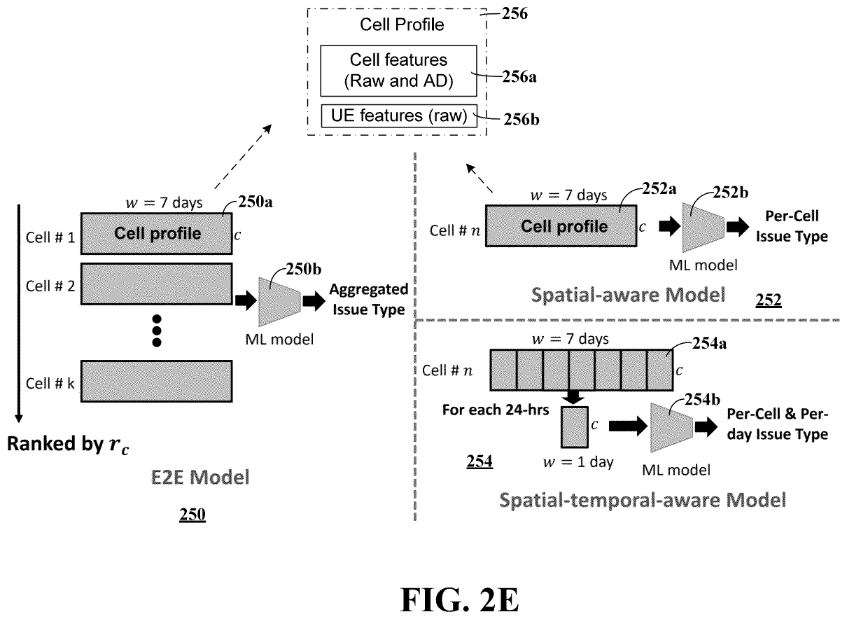

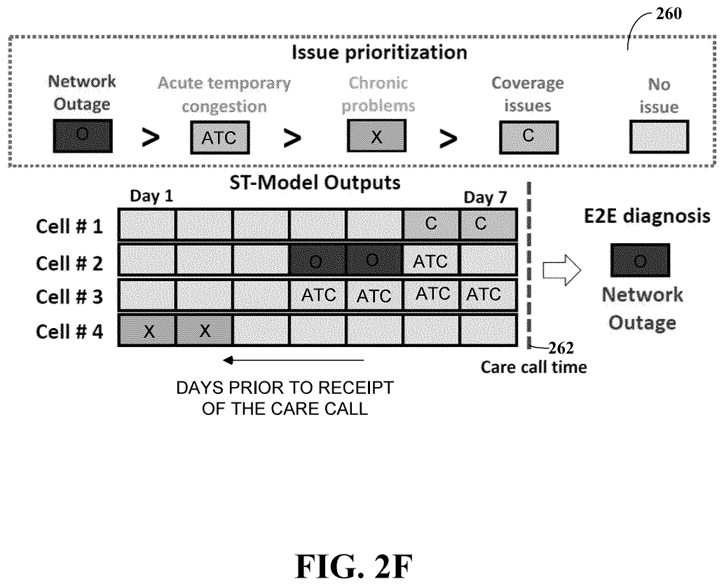

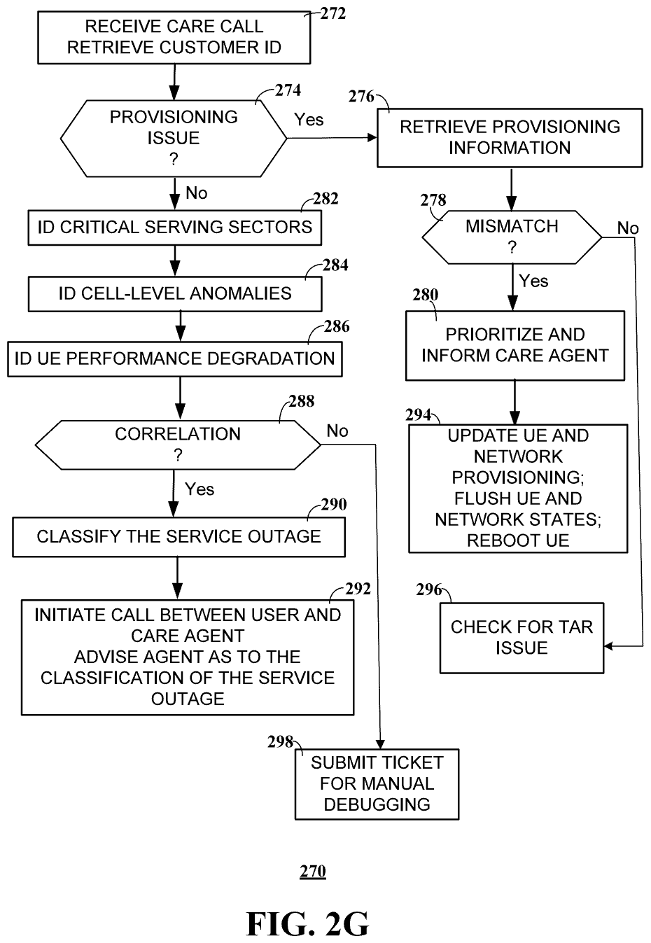

FIG. 2A is a block diagram illustrating an example, non-limiting embodiment of a cellular network 200 functioning within the communications network 125 of FIG. 1 in accordance with various aspects described herein. The cellular network 200 includes a radio access network (RAN) 202 providing radio communication to user equipment (UE) 204 and a core network 206. The exemplary cellular network 200 uses 2 radio access technologies, including fourth generation (4G) cellular or LTE and fifth generation (5G) New Radio (5GNR). Other example cellular networks may use other radio access technology (RAT) and combinations of RATs.

Operational cellular networks often contain multiple radio access networks (RANs) and cellular cores for providing user connectivity. User equipment (UE) devices are provisioned by the network operator with an Access Point Name (APN) that allows cellular networks to direct the user connectivity requests to the appropriate core.

The radio access network 202 provides radio communication to the UE 204. The UE may include a wide variety of user devices such as mobile phones, smart phones, wearable devices such as watches and portable devices (e.g. tablet computers). In embodiment, the UE 204 may also include laptop computers and Internet of Things (IoT) devices. The UE 204 communicates using radio spectrum with the radio access network 202 according to the appropriate radio access technology.

The core network 206 provides a number of support and control functions for managing activity in the radio access network 202. Such functions include, for example, mobility management, authentication and authorization, and others. In the example of FIG. 1, the core network includes multiple core networks, including an evolved packet core (EPC) 206a, a control and user plane separation (CUPS) core 206b, and a 5G core (5GC). The EPC 206a implements functions associated with the 4G or LTE capabilities of radio access network 202. CUPS is a network architecture where the control plane functions like call setup, authentication, and resource management are separated from the user plane functions like data transmission. The 5GC core 206c is the basic infrastructure of a 5G cellular network. The core network 206 further provides communication to networks other than the radio access network 202, including the public internet.

In the illustrated example, the LTE portion of the RAN 202 is connected to the EPC core 206a and CUPS core 206b. The 5G-NR portion of the RAN 202 is connected to the CUPS core 206b and the 5G core 206c. In embodiments, a RAN antenna consists of multiple sectors; each sector typically covering a 120 degrees and using a predetermined frequency for transmission, referred to as a RAN-carrier. A cell is a combination of a sector and a RAN-carrier that is used for transmission. An eNodeB/gNodeB supports multiple cells.

The cellular network 200 generally provides reliable service to users including UE 204. At times, for a user or group of users, service is degraded and users may notice the degradation. Cellular service degradation could impact voice service, data service, or both. Depending on the root causes of the service degradation, corresponding resolution actions may include explaining or updating billing information, reactivating a customer's UE device, replacing a subscriber identity module (SIM) of the customer's UE device, upgrading software, explaining on-going network problems, or creating trouble tickets, as well as others.

In cellular network operations, most network issues can be proactively detected and managed based on the network level observations without customer engagement. However, when coming to troubleshooting individual user-level service problems, the impacted user may seek assistance from the network operator or cellular service provider (CSP) to resolve issues related to a particular UE (user equipment).

Troubleshooting cellular service issues is inherently challenging due to the lack of fine-grained user data and the complexity involved in cellular network design, user mobility, diverse vendors of user devices and third-party mobile applications.

Customer care service have been the primary channel for users to report and to resolve cellular service issues. Though CSPs have developed systems and tools (also referred as workflow) that guide care agents step by step through the troubleshooting process, this process is still largely manual and often requires long and intense interactions between users (also referred as customers) and care agents. The performance of care agents is therefore a key factor that impacts the overall customer satisfaction and hence CSPs strive to improve the efficiency of service troubleshooting and resolution for users. Traditionally, when a user contacts the customer care operation of the network operator and reports a service issue, a human care agent interacts with the user and initiates a troubleshooting and resolution process. In practice, the troubleshooting and resolution process is largely an interactive process between the user and care agent and is often guided by a designated workflow.

FIG. 2B. illustrates a conventional troubleshooting and resolution workflow 210 for resolving a customer service issue in a cellular network such as the cellular network 200 of FIG. 2A. The workflow 210 includes a customer inquiry process 210a, an account resolution process 210b, an account and routing issue resolution process 210c, a device troubleshooting process 210d, and data collection process 210e. Other embodiments may include other or additional processes.

When a cellular network user contacts customer care and reports a service issue, the care agent initiates the troubleshooting and resolution process, which is largely an interactive process between the user and care agent and is often guided by a designated workflow. The example troubleshooting and resolution workflow 210 illustrates how a series of possible causes are checked based on information provided by the user, and resolution actions are executed according to diagnosis results. If the service issue is not successfully diagnosed or resolved at the end of the workflow (e.g., unknown network failures, external events that need to engage service partners and device vendors), a trouble ticket is created and dispatched to tier-2 support team for further investigation.

In the customer inquiry process 210a, a customer contacts a care agent employed by the network operator. The care agent in this example is a human with access to information about network and account issues. The access may be by voice, over telephone line, or online by text interaction. During the customer inquiry process 210a, the customer describes symptoms of the service degradation the customer is experiencing. The symptoms may include dropped calls, a slow data rate for data activities, lack of service, and other symptoms.

Next steps in the workflow 210 involve responding to the issues or symptoms described by the customer. For example, if the customer described a slow data rate or lack of service, at the account resolution process 210b, an effort is made to identify and correct any account issues that the user may be experiencing. For example, the customer's account with the service operator may have been inadvertently disabled. This may be addressed by the care agent and corrected. If the customer's issue has been resolved, the troubleshooting workflow 210 is exited.

In another example, if the customer reports dropped calls, at the account and routing issue resolution process 210c, the process may include resending an activation message or code to a user device of the customer to reactivate the connection between the user device and the network, or reconfiguring an access point name (APN) operated by the network operator and providing network access for the customer, or other steps. If the customer's issue has been resolved, the troubleshooting workflow 210 is exited. On the other hand, if further information is required, the data collection process 210e may be entered. The data collection process 210e may include features of capturing the time and location when an issue reported by the customer has occurred, verifying coverage for the customer at that location and during that time. Further, the data collection process 210e may include consulting other network resources to identify any other known issues that may have occurred at that location or at that time. If a known issue is found, the workflow 210 is exited and the care agent may inform the customer about the issue and provide suggestions for resolution.

In a third example, if the customer reports device issues, at the device troubleshooting process 210d, the care agent may initiate a software update for the control software of the user device, a rebooting of the user device, a reconfiguration or SIM replacement for the device, etc. Other steps may be taken as well. Actions such as rebooting the phone or downloading software may be considered actionable, and after the customer is advised appropriately, the workflow 210 may be exited. On the other hand, some required or recommended actions may be considered non-actionable and may cause generation of a device ticket. Such a device ticket will require the customer to visit a retail location or pursue other means for resolving the customer issue. Still further, if no issue is found after executing an account resolution process 210b, the account and routing issue resolution process 210c, the device troubleshooting process 210d, a trouble ticket may be generated. The workflow 210 will then be exited.

However, this conventional troubleshooting and resolution workflow 210 is not optimally accurate and efficient. Troubleshooting cellular service issue is inherently challenging. The workflow 210 shown in FIG. 2B leverages domain knowledge gained from decades of experience of service operation and customer support. The order of key diagnosis steps can evolve over time and can vary across different service providers. In addition, both the user and their devices are highly engaged throughout the troubleshooting and resolution process. Many key diagnostic steps often need to be carried out sequentially to avoid interference.

In one analysis of the timeline of a care call, a total of 21 minutes was required to handle the call by the care agent. In this example, the source of the problem was local RAN congestion due to a natural disaster and nearby network outages. A first interactive process with the customer of gathering information about problem type, device information and account information, required approximately one minute. Collecting information about the time and location of the occurrence of the problem, a mostly manual operation for the agent, required approximate 2.5 minutes. Checking for and resolving a provisioning issue required approximate 4.5 minutes for the agent. Checking for a network issue require approximately 1.5 minutes and, in the actual example, resulted in a false negative. The agent did not discover that the source of the problem was a network issue. Performing other troubleshooting required approximately 9 more minutes, and the issue was still not resolved in the example. The agent then prepared a trouble ticket to escalate to the tier 2 support team which required approximately 3 minutes. In a preferred mode of operation, a total of less than 3 minutes should be required to handle the call including 1.25 minutes to gather information and 1.5 minutes for checking the status of the network.

There are two widely used metrics to measure the efficiency of a troubleshooting processes such as the workflow 210. A first metric considers how accurate the troubleshooting results are. A second metric considers how long the troubleshooting and resolution process takes. Accurate diagnosis can help avoid unnecessary efforts to resolve the issue, eliminate the need for customers to contact care repeatedly, and reduce the risk of losing customers. Timely resolution can help minimize the service disruption for customers, reduce waiting time for other customers who seek assistance from care agents, and improve operational efficiency of cellular providers.

To achieve better efficiency, care agents need to quickly identify most likely causes of service issues and execute corresponding resolution actions. This can be quite challenging due to inherent complexity in correlating network usage and performance data with individual user perceived performance. In addition, users are often not able to provide comprehensive and accurate information regarding the service issues that they experienced. Ambiguous or incomplete information provided by users impose additional complexity in diagnosing service issues.

FIG. 2C is a functional block diagram illustrating an exemplary pre-diagnosis module 220 for operation with an improved troubleshooting and resolution workflow for resolving customer service issues in a cellular network such as cellular network 200 (FIG. 2A). The pre-diagnosis module 220 may be used to implement an improved and more efficient workflow for identifying and addressing customer care issues in a cellular network. The pre-diagnosis module 220 includes a customer inquiry process 220a, an auto-diagnosis process 220b, an issue resolution process 220c and an automatic resolution process 220d. In other embodiments, the pre-diagnosis module may include other or additional processes or modules. The pre-diagnosis module 220 may be implemented in any combination of hardware and software. Moreover, the pre-diagnosis module 220 may be located at any suitable location in a network, in data communication with other elements of the cellular network 200.

The customer inquiry process 220a may operate much like the conventional customer inquiry process 210a of FIG. 2B. In embodiments, a customer contacts a care agent employed by the network operator. The care agent in this example is a human with access to information about network and account issues. The access may be by voice, over telephone line, or online by text interaction. During the customer inquiry process 220a, the customer describes symptoms of the service degradation the customer is experiencing. The symptoms may include dropped calls, a slow data rate for data activities, lack of service, and other symptoms.

One aspect of the customer inquiry process 220a is detection and collection of customer identification information for the customer. Any suitable customer identification information may be collected and used. In one example, the customer's telephone number assigned to the UE or other device of the customer may be used to identify the customer. Based on the customer number or other customer identification information, the pre-diagnosis module 220 automatically collects customer information about the customer and the customer's device. Such customer information may be retrieved from any suitable location such as from stored information of the network operator. Such customer information may include account information of the customer, make and mode of the customer's device, and historical data about usage of the device in the cellular network. For example, the network operator automatically collects and stores information about the cells visited or access by the user's device, handovers from one cell to another, key performance indicators (KPIs) for the device and for the network, and other information. The customer information provides a detailed picture about usage and experience of the customer's device and the customer on the cellular network over a designated period of time, such as one week, one month, or the lifetime of the user's device.

Retrieval and processing of the customer information may occur as a background process during the customer inquiry process 220a. For example, if the customer places a phone call to the customer care service of the cellular network using the cellular network the calling line identifier (CLID) for the customer's device is reported to the network with the call. The CLID may be used as customer identification information to identify the customer and the customer's device and to collect and retrieve the customer information.

The auto-diagnosis process 220b includes in this embodiment an artificial intelligence (AI) or machine learning (ML) module, ML module 222. The auto-diagnosis process 220b receives the customer data associated with the customer as well as back-end network log data. The network log data may include any data collected by the cellular network 200 or the network operator regarding functioning and operation of the cellular network 200. The network log data may include information about devices active on the network, key performance indicators for various components of the network such as UEs attaching to each cell or sector in the network and UEs handing over to other cells in the network. The network log data may further include information about network outages and downtime, network congestion, etc. In addition, raw data may be aggregated and processed to determine such information for a portion of the network, for a particular time period, etc.

Thus, the ML module 222 obtains input information including customer information about the customer and network log information about activities in the cellular network 200. The ML module 222 may thus perform a pre-diagnosis based on this information to determine, for example, whether the customer issue is an account issue, whether the customer issue is a network subscription and mobility (NSM) issue, and whether the customer issue is a transport and RAN (TAR) issue.

If the customer issue is determined to be an account issue, a fix account issue process 224 may be initiated to address the account issue. For example, the user's data plan may need to be renewed or revised to permit the activity the user currently wants to accomplish. The fix account issue process may be performed manually by the care agent or automatically, once the account issue is identified by the auto-diagnosis process 220b. Upon completion of the fix account issue process 224, the auto-diagnosis process 220b may be exited.

If the customer issue is determined to be an NSM issue or a TAR issue, an automatic resolution process 220d may be initiated. The automatic resolution process 220d includes a first automatic step of fixing or correcting the account or routing issues that are identified by the auto-diagnosis process 220b. Such issue resolution may include reconfiguring some aspect of the user's account or the routing of user data and calls in the cellular network to correct the issue. Examples include resending an activation code or signal to the user's device, reconfiguring the APN assigned to the user's device, etc. The automatic resolution process 220d may further include an automatic informing and reporting process in which the agent or an automated process informs the customer about the issue and a suggested resolution. Examples include suggesting local modifications the user can make such as installing a signal boosting device to improve signal strength.

Upon completion of the automatic resolution process 220d, the auto-diagnosis process 220b may be exited. In some embodiments and for some customer issues, a device troubleshooting process 220e may be initiated.

The device troubleshooting process 220e is directed toward identification and resolution of problems with the user device of the customer. In some instances, the car agent may identify a device issue during the customer inquiry process 220a. The device troubleshooting process 220e may include any steps necessary to identify and resolve a device issue with the user's device that is causing the current customer issue. Such device issues may include out of date software on the user's device, incorrect hardware such as a subscriber identity module (SIM), etc. The device troubleshooting process 2203e may recommend a suitable action such as updating software or SIM to resolve the device issue. If the device issue is actionable, the auto-diagnosis process 220b may be exited. If the device issue is non-actionable, a device ticket is generated for further attention, such as at a retail location of the network operator. In some cases, a trouble ticket is generated and the issued of the customer is escalated to a tier 2 team for investigation.

In embodiments, the ML module 222 is data-driven and applies ML models on data collected from the cellular network to investigate possible root causes of a service issue simultaneously. Specifically, the ML module 222 focuses on automating the diagnosis of two categories of service issues. A first category includes core network and user provisioning issues, referred to as Network Subscription and Mobility (NSM) issues. The second category includes Radio Access Network (RAN) problems and is referred to as Transport and RAN (TAR) issues.

The ML module 222 identifies root causes and solutions. The real-time prediction results of the ML module 222 generate an ordered list of possible root causes with corresponding recommended resolutions. The recommended resolutions can be readily used by agents to prioritize resolution of the most likely root cause. This can significantly reduce the handling time. More importantly, the ML based recommended resolution produced by the ML module 222 takes a comprehensive view of the data collected from elements of the cellular network 200 and reduces the inaccuracy in troubleshooting service issues.

The ML module 222 leverages insights learned from network log data and historical customer care log data for root cause diagnosis and needs in order to address several data related challenges. First, training and validating a representative set of ML models on a massive volume of network data with rich spatial and temporal context is nontrivial. Second, because the details provided by users regarding their service issues are usually ambiguous or inaccurate, it is challenging to pinpoint the piece of data from which the root cause can be identified. Such user-provided details may include for example, when, where, and what service issue occurred. Third, network data does not contain information that can only be captured from user device. For example, if the service issue is caused by user device hardware defects, the ML module 222 would not be able to identify such user device issues. However, the ML module 222 can help rule out possible root causes in the cellular service provider domain, allowing care agents to quickly focus on device troubleshooting. Fourth, there is limited ground truth information available in historical customer care logs that can be used to train the ML module 222 for pre-diagnosis. For example, the current manual troubleshooting flow, based on which historical care log data is collected, may not accurately identify every true root cause.

There is lack of conventional, existing methods that can properly correlate cellular network performance, user device performance, mobile application performance, and user perceived performance to offer troubleshooting insights. Diversity in user devices, third party applications, geographic features, and user behaviors (usage and mobility) further increase the complexity of the problem.

The troubleshooting and resolution process needs to operate in real-time to assist agents during customer care calls. Thus, real-time prediction by ML module 222 is crucial in improving the efficiency of the process. In design of the ML module 222, ML models are favored that can provide reasonably accurate prediction results while maintaining low operational costs, including the operational cost of training and running of the model. Additionally, when deploying these models in real-world situations, it is crucial to consider the interpretability of the model's outcomes. Therefore, use of simpler models that yield explainable results is favored. This not only lowers the cost of running the model, but also makes the handling of fall-outs (i.e., when an ML model fails to provide correct results) more manageable.

FIG. 2D depicts a block diagram of a machine learning module (ML module) 222 for use in conjunction with the pre-diagnosis module 220b of FIG. 2C, in accordance with various aspects described herein. The ML module 222 includes in this exemplary embodiment a network subscription and mobility (NSM) issue process 232 and a transport and RAN (TAR) issue process 234. In other embodiments, the ML module 222 may include other or additional functions and processes.

Operation of the ML module 222 may be initiated upon receipt of information about a service issue from a customer of the network operator, or a user of the cellular network. This may occur, for example, when the user contacts a customer care agent of the network operator for assistance and to report the service issue. Both the NSM issue process 232 and the TAR issue process 234 receive input information about a service issue experienced by a user on the cellular network. In an example, the information about the service issue includes user identification information such as mobile phone number associated with the user or the device of the user experiencing the service issue. In other examples, suitable identification information may be received such as an International Mobile Equipment Identity (IMEI) number of International mobile subscriber identity (IMSI) associated with the user or the user device.

In embodiments, the ML module 222 diagnoses both NSM and TAR issues simultaneously and presents all detected issues to the customer care agents. If both NSM and TAR issue exist, the agent may first rule out NSM issues since the issue is deterministic and usually can be addressed by care agents. In an example, addressing an NSM issue requires accessing provisioning information of the account of the user and re-provisioning the user device. If the service problem persists, the agent may further look into TAR issues. In case of a known TAR issues, care agents may inform the customer of ongoing issues and recommend to the customer use of alternate solutions such as Wi-Fi calling.

The outcomes of ML module 222 are used to drive the selection of the system workflow used by Tier-1 customer care agents when troubleshooting a specific service issue. For this purpose, the overall system requires a conclusive diagnosis result (i.e., the issue type) from the ML module 222. In rare cases, if the model makes inaccurate inference and the issue cannot be resolved by Tier-1 agents, a ticket may be created and forwarded to a Tier-2 care team, who can leverage more fine-grained intermediate outputs of the ML module 222 for manual and in-depth issue investigation.

Any suitable input data may be provided to and used by the ML module 222. In examples, the ML module 222 uses data collected from a cellular service provider for system design, training, and evaluation. UE-level key performance indicator (KPI) KPI data may be collected at RAN elements such as eNodeBs and gNodeBs at cell sites of the cellular network. This raw data is presented as a sequence of timestamps and events at UE-level. Measurements are aggregated per time bin (e.g., 15 minute bin) and per cell for each UE during pre-processing. The UE-level KPIs include, for example, user Radio Resource Control (RRC) channel and traffic measurement logs generated when a RRC channel or data radio bearer is established. The data captures detailed handover activities, radio measurements such as Reference Signal Received Power/Quality (RSRP/RSRQ), Channel Quality Indicator (CQI)), and traffic measurements such as downlink (DL) and uplink (UL) traffic volume and throughput of each individual UE when connecting to each cell.

The ML module 222 further makes use of cell-level KPI data. Cell-level KPI data may be generated in the cellular network by periodically aggregating the performance measurements, such as traffic and radio measurements, of all UEs connected to the cell. The data provides a view of how a RAN cell performs and is computed by aggregating each KPI every 15 minutes, or other suitable time period. In one embodiment, the ML module 222 uses 21 KPI's including RAN retainability and accessibility rates, DL/UL traffic measurements and statistics (e.g., volume, average throughput, packet loss rate, etc.), control and data channel resource utilization (e.g., Physical resource block (PRB) utilization), number of active/new RRC connections, and handovers. Other or additional KPI's may be used in other embodiments.

Although finer-grained KPI data may provide a more detailed view of UE or cell performance trajectories, it also tremendously increases the overhead of storing and processing these data in real-time. For example, if KPI data is aggregated in 1-minute bins, the data storage cost and data processing bandwidth requirement would increase by at least a factor of 15 compared with the illustrated embodiment. On the other hand, users typically do not call customer care immediately after experiencing a short or temporary issue. Short and one-off service glitches or traffic jitters may happen for a variety of reasons in the real world. Only the long-lasting or intermittent issues lead to care calls and 15-minute KPI bins can effectively capture these issues. Hence, illustrated setup is adopted to balance the trade-off between cost and observation granularity.

Charging Data Records (CDR) of the cellular network may be used as well. Data plane CDRs are generated by home network data plane gateways by periodically (typically hourly) aggregating the data plane traffic for each user. The ML module 222 uses the CDR data to extract the access point names (APNs), data plane gateway instances, and domestic/international roaming information used in NSM issue diagnosis. In addition, CDRs generated by control plane elements capture UE to network interactions such as attach/detach and hand-offs.

The ML module 222 uses the customer care interaction data logged during the troubleshooting workflow and customer ticket data for training and evaluation. Specifically, for each troubleshooting session of the care call, the data records the session start and finish time, issue description from the customer (agents select a category that best matches the issue from a pre-defined list, such as “unable to make or receive voice calls” or “slow data”), and intermediate or final diagnosis results (e.g., the output of the steps in FIG. 2A) using current troubleshooting functions. Other data may be recorded as well in other embodiments. In addition, the data also logs the start and finish time of important system APIs invoked by care agents during the troubleshooting workflow. The system APIs (such as “update UE provisioning,” “inquire known outages,” “create tickets,” etc.) provide information about what steps were taken by the agent, while the timestamps enable an understanding of the time cost of each diagnosis or problem resolving step during care calls. If a ticket is created for the care call, issue diagnosis and resolution information in the ticket may be used to understand the root cause of the problem.

Note that customer care data does not record detailed conversation between care agents and customers for privacy reasons. The ML module 222 does not use Personally Identifiable Information (PII) data in its analysis. Network data is logged using encrypted identifiers that allow identification of traffic to and from a user. However, data used by the ML module 222 does not contain subscriber identifiers. Furthermore, network data only logs network service performance and does not contain any information about its contents.

The NSM issue process 232 identifies and resolves provisioning for the device or account of the user who has identified the service issue. Provisioning in a cellular network refers to the process of configuring and activating network elements to support new services or subscribers. Provisioning may be considered the act of setting up the network to handle additional traffic or functionality. Provisioning may include configuring user subscription parameters like data limits, voice minutes, and SMS messages. Provisioning may also include activating new services for subscribers (e.g., 5G, voice over LTE (VoLTE) service, roaming) and configuring service parameters (e.g., data speeds, quality of service). In general, NSM issues occur when the state information on the user device is inconsistent with the state stored in the core network. The NSM issue process 232 retrieves provisioning information 232a such as a provisioning log for the customer. A rule-based verification process 232b is applied to the provisioning information to identify any provisioning failure or mismatch. Any suitable set of rules may be used to verify the provisioning for the customer or the customer's device. An example of a mismatch may have the actual account provisioning for the customer varying from what is intended or agreed upon for the customer.

Any identified provisioning-type issues can be prioritized in a prioritization process 232c and corrected by the care agent in a correction process 232d. For example, the correction process 232d may be relied on to correct any identified provisioning issues, roaming issues, mobility issues and uncategorized issues. The correction process 232d may be implemented automatically to modify and update the provisioning and core data 232a of the user. For example, this may be done by automatically accessing an application programming interface (API) to modify the provisioning information for the user. The correction process 232d may alternatively be manually performed by the care agent accessing an API to manually modify and correct provisioning data and other information of the customer's account. Thus, provisioning issues are typically resolved by updating the device/network provisioning and forcing the UE to reattach to the network after flushing the UE and network states using a network initiated detach procedure.

NSM issues may fall into three categories. A first category includes provisioning issues. Provisioning issues result from cases where the user device is incorrectly provisioned. For example, the user is not able to connect to the network as the user is using an incorrect APN or an APN which is not allowed by the user's subscription. In another example, the user device is provisioned with a subset of APNs or it is not creating APNs required by its subscription due to an error.

Mapping user described symptoms to provisioning issues can be challenging as user devices handle APN attach failures in different ways. For example, the user device may choose to tear down all existing APNs when it fails to attach to any one of the APNs or it may choose to remain partially connected, in which case user will have partial service which can lead to loss of voice or data service, or slower speeds in cases where dedicated APNs are deployed to support specific applications.

A second category of NSM issues includes roaming issues. Roaming issues occur when the user is not connected to the user's home network RAN. Outbound roaming cases include, for example, international roaming, which occurs when the user has traveled away from the home country and the user subscription does not allow or limits roaming. Outbound roaming cases further include, for example, domestic roaming, which occurs when the user attaches to a domestic partner network due to coverage issues or temporary network outages. Domestic roaming can be triggered by a TAR issue, therefore, the ML module 222 also presents the TAR issue diagnosis to care agents in case of domestic roaming.

A third category of NSM issues includes mobility issues. User mobility can sometimes lead to conditions where the user traffic is not optimally routed in cellular network which can impact user performance. These mobility issues can be resolved by reconfiguring the UE to route traffic to the correct gateways. This may typically be done by triggering a network initiated detach procedure.

Given that NSM issues can be inferred from the CDR data, a policy-based method may be used to identify UEs impacted by NSM issues. During the analysis some customers were found to have more than one NSM issue. Therefore, embodiments of the ML module 222 use the prioritization process 232c and the following priority order to recommend corrective actions: international roaming, provisioning, mobility, domestic roaming. This order is chosen because international roaming needs a specific provisioning profile, the fix for provisioning issue is a superset of the fix needed for mobility issues, and domestic roaming can be triggered by a TAR issue and needs further analysis. Other prioritizations may be used. Note that user consent is required before updating user provisioning and disconnecting user devices from the network. This may limit the opportunity of fully automating the resolution actions in practice. NSM diagnosis therefore may rule out provisioning errors and roaming scenarios before addressing TAR issues and device issues. Further, NSM diagnosis enables care agents to execute corrective actions for partial failures such as mobility and provisioning issues that require user consent.

The other path through the ML module 222 uses machine learning for network standard problem identification. The provisioning check performed by the NSM issue process 232 is deterministic in nature. Based on the data, the NSM issue process 232 can identify the root cause of the service issue precisely. However, for the network side, the TAR issue process 234 is more in the nature of a correlation. In effect, the network operator knows that something happened in the RAN, and the customer has identified a service issue. If they can be correlated, it is very likely that the RAN issue has caused the customer impact. Accordingly, the TAR issue process 234 uses a probabilistic model.

In the TAR issue process 234, first the critical serving cell sectors are identified based on the time of the service issue and the user identification information. After a candidate set of sectors or cells has been identified, the TAR issue process 234 will investigate what happened in each of them at the critical time. Next, cell-level or sector-level KPI information and user level KPI information is retrieved from network performance data 242 for times when the user was attached to that sector or cell. The TAR issue process 234 can determine if there was abnormal behavior in the sector at that time and, if so, determine based on the UE-level data and the cell-level data if they can then be correlated together.

A machine learning model 244a operates to decide if a degradation in UE performance at a particular time correlates with an anomaly in behavior at the cell to which the UE is attached. The goal of the machine learning model 244a is to classify 244c the customer service issue and determine if it is a network outage, temporal congestion in the network, a chronic problem, a coverage issue, or something else, other than a cell-scale issue.

A model training phase 244 may be entered for a machine learning model 244a. The machine learning model 244a may be trained using historical customer care data 244b.

Thus, the TAR issue process 234 uses ML models trained on network and customer care data to classify UE events into different types of Transport and RAN (TAR) issues that impact user-level service performance. The ML module 222 leverages network service performance data and historical customer care log data to determine if a given UE-level service issue is caused by a Transport and RAN (TAR) issue. The ML module 222 may further classify each TAR issue into the following categories: (1) Network outages, in which the cell is completely out of service due to an outage or planned maintenance; (2) acute temporary congestion, in which the RAN is severely congested due to temporary or emerging events, such as nearby outages or external events; (3) chronic network problems: performance of the cell remains degraded for extensive period due to network changes, RAN/core mis-configuration, capacity limitation, and external issues, etc.; and (4) coverage problems, in which the user is in a poor coverage area. The ML module 222 includes online diagnosis and classification to help the customer care team provide accurate information to users about the TAR issues they experienced, and the network engineer and operation teams to track impact of known and unknown service issues.

In the example embodiment of FIG. 2D, the TAR issue process 234 includes a critical serving sector extraction process 236, a cell-level feature profiling process 238 and a UE-level feature profiling process 240. These processes may retrieve and process network performance data 242.

The critical serving sector extraction process 236 operates to determine and identify cells that served the UE during the reported time of the service issue. In one example, the current TAR issue process 234 uses a radio resource control (RRC) log from the UE to determine the serving cell during the reported issue time. However, the effectiveness of this method may be limited due to several factors. First, the reported issue time might not be available or precise in practice. Second, the user device might be handed-over to a neighboring cell while the primary serving cell is under outage. Third, if the UE loses service completely, there may be no RRC sessions with any cell during the issue time. A critical serving cell may be defined as a cell to which the UE attaches for an extended period. For example, a UE in a vehicle traversing several cells will attach to and hand over from each of the several cells, even though the attachment time may have been very short and may not correlate with the reported issue time. Any suitable time threshold may be used or determined to determine if the UE attached to the cell for an extended period. Therefore, to conduct a thorough and automatic pre-diagnosis in the ML module 222 without agent-customer interaction, it is necessary to investigate all potential critical serving cells for the UE and correlate the service degradation at both cell and UE levels.

However, identifying the critical serving cells for a UE is non-trivial owing to UE mobility, handovers, and the ambiguity of the user-reported incident time. In fact, the discrepancy between the user-reported incident time and the actual incident start time may vary significantly case-by-case depending on the specific user case scenarios and the root cause of the TAR issues. For acute service outages, this time discrepancy is typically a few hours; while for chronic problems, the discrepancy could be as long as a few days. During this period of discrepancy, the UE may connect to tens or even hundreds of different serving cells. For example, collected network data show that, in a 24-hour period, more than fifty percent of UEs attached to more than 20 cells, and more than ten percent of UEs connected to more than 100 Cells. In some embodiments, the ML module 222 uses the precise issue time and duration of customer issue for analyzing if a user is impacted by the TAR issue. However, this information may not be available to the ML module 222 in the pre-diagnosis stage.

Hence, the ML module 222 needs to infer a candidate list of critical serving cells and perform deeper analysis on each candidate cell. The network performance data 242 includes a time stamp value measured at each cell visited by the UE and a KPI measurement for that time stamp. This data can be aggregated and used to form a trajectory for the user and user device. The trajectory can be established in, for example, five-minute bins and used to compute the utilization ratio for each cell. The cells can be ranked by utilization ratio.

Specifically, the ML module 222 identifies the candidate list based on the utilization ratio of each cell for the UE. For a serving cell c, time bin of |b|, and investigation window w, the cell utilization ratio r_{c} is defined as

$${r}_{c} = \frac{n \vert b \vert}{\vert w \vert} \vert ,$$

where n is the number of time bins in which cell c serves the UE in time window w. Thus, for a given time duration w, the larger the r_{c} is, the more important the cell c is to the UE with respect to potential service quality impact.

Since the service issue time is unknown, the ML module 222 computes r_{c} values varying investigation window w from 1 hour (ongoing issues) to 7 days (chronic issues). The ML module 222 identifies all cells with r_{c}>rₜₕ during any window w as critical serving cells for the UE, sorted by r_{c} values. The value of rₜₕ may be determined based on the trade-off between system overhead for cell service quality profiling and investigation completeness. For typical cellular network data with rth=10% in an embodiment of the ML module 222, 99.5% of the UEs have fewer than 20 critical serving cells. Based on customer care operation experiences, these top 20 candidate serving cells well cover potential root causes of service issues. This is because users generally do not report problems with cells they rarely use, such as the ones they connect to briefly while driving through an area.

The cell-level feature profiling process 238 determines information about cell-level service quality features. The ML module 222 uses two types of features. First, the ML module 222 uses cell-level raw KPI time series data, aggregated using 15-minute time bin, for example. Second, the ML module 222 uses anomalies detected in cell-level KPIs. These anomalies can be potential indicators of service degradation that impact UEs served by the cells.

The following five abnormal patterns in KPI time series may be considered. A first abnormal pattern includes missing data points. This abnormal pattern is usually observed when the cell is out of service due to maintenance or outage. For example, collected network data may show that the cell has abnormal RAN retainability ratio on particular days of a week. A second abnormal pattern includes chronic abnormal values. In this example, the service KPI degrades due to chronic issues. In an example, collected data show that the cell has chronic low UE-throughput over a period of 7 days, aggregated for all UEs served by this Cell. A third abnormal pattern includes temporary fluctuations. Such temporary fluctuations are usually observed when the network is temporarily congested. In an example, collected network data show an example anomaly in average RRC connection numbers of a cell.

A fourth abnormal pattern includes level shift. In this abnormal pattern, the KPI pattern changes significantly compared to the historical baseline and the change lasts over an extensive time period. This is usually observed when the network configuration is permanently changed. A level shift in average RRC connection numbers of a cell may occur due to a variation in an operating parameter for a cell. A fifth abnormal pattern includes spikes. In this abnormal pattern, the KPI changes acutely for a very short time duration due to traffic spikes or external events. Collected data may show spikes in the physical resource block (PRB) utilization of a cell.

The ML module 222 detects anomalies in each cell-level KPI time series using the following methods. Except for the Thresholding method, anomaly detection models are trained using three months of historical Cell KPI data.

In a thresholding method, the ML module 222 leverages domain knowledge from RAN operators to set thresholds for each cell-level KPI. An example includes known chronic throughput issues. In a seasonal model, most cell-level KPIs exhibit a daily pattern. In some embodiments, the ML module 222 uses a Holt-Winter model to learn seasonality in each cell-level KPI and detects anomalies. In a level shift detector the ML module 222 detects level shift over, for example, a 24-hour sliding window. In autoregression, the ML module 222 applies liner regression on cell-level KPIs using, for example, a 2-hour time window to capture acute changes and spikes (e.g., FIG. 11).

The cell-level feature profiling process 238 produces, for example, a list of up to 20 cells to investigate further. The usage profile for each cell is then retrieved. A first usage profile is the cell level or cell sector level, which includes average KPIs or aggregated KPIs for all users using the cell over time. An anomaly detector may be applied to retrieve those anomalies which may be relevant to customer experience. There are several types of anomalies. One example is a missing data point which typically corresponds to an outage when the cell was offline for a time. A second example is an out-of-range KPI value such as throughput. A third example is a pattern shift in the data. A fourth example is a traffic spike at a location and a time.

UE KPI data may then be compared with the anomaly information. UE KPI tends to look more random or noise-like. The UE KPI data corresponds to UE performance at the time the UE was connected to a particular cell. In cases where a degradation in UE KPI information correlates with an anomaly at the cell, the ML module 222 can infer that the degradation is not because of any user behavior change but because of the anomaly at the cell. A machine learning model may perform the correlation.

In more detail, then, the UE-level feature profiling process 240 operates on UE-level KPIs as time-series data. Each KPI is aggregated at per UE per cell level in a 15-minute time bin. Other duration time bins may be used. This allows correlation of UE-level performance degradation with critical serving cells. In embodiments, the ML module 222 computes the following UE level KPIs aggregated using a 15-min time bin: (1) Signal and channel quality: Average RSRP, RSRQ, and CQI; (2) Traffic: Average downlink (DL) and uplink (UL) traffic volume and throughput; (3) RRC Message rate: Number of RRC messages for signal channel measurements. The higher the number of RRC measurement messages, the more active is the UE.

UE-level KPIs can be greatly affected by user behavior, network performance, and other external factors. For instance, reduced throughput in some instances may be mainly due to low activity of the UE on a particular cell. Degradation on another day may be mainly caused by the network congestion on the serving cell. Accordingly, an abnormal UE-level KPI does not necessarily indicate service quality degradation.

Identifying the impact of a TAR issue on a UE requires observing the temporal correlation between UE and cell service performance degradation. The ML module 222 profiles the service quality history of both the UE and its critical serving cells into a format suitable for ML models.

Three schemes may be considered for profiling the features based on cell and UE-level data. FIG. 2E illustrates three candidate feature profiling methods for use with a machine learning model to profile a service quality history of a user equipment and its critical serving cells. The candidates include an end-to-end (E2E) model 250, a spatial aware model 252 and a spatial-temporal aware model 254.

For every cell, for every UE, a cell profile 256 is generated. The cell profile 256 forms a feature matrix. The cell profile 256 includes cell-level features 256a such as KPIs and information about anomalies detected by an anomaly detector (AD). The cell profile 256 further includes UE features 256b. The cell profile 256 including both the cell-level features 256a and the UE features 256b is prepared as time-series data. The cell-level features 256a and the UE features 256b can be concatenated over the time channel to form multi-modal time series data.

One objective of the E2E (end-to-end) model 250 is to determine the most probable root cause of the UE's service problem by correlating the UE-level KPIs with the serving cell KPIs of the cells that the UE used in the past several days. Specifically, for each serving cell for a user, the cell KPI timeseries are concatenated or otherwise grouped with the detected cell performance anomalies (as timeseries), and the UE KPIs timeseries along the time dimension and create a multi-channel time-series feature block 250a designated “Cell profile” in FIG. 2E. This forms a large feature matrix. In this way, each cell profile captures the UE's experience on the target cell, corresponding cell KPIs, and performance anomalies (if any) observed on the cell. All cell profiles may be concatenated, ranked by r_{c} (the utilization ratio) of each cell, to create the case profile input for an ML model 250b. For the end-to-end model 250, all data are concatenated together and provided to a machine learning model.

In the spatial aware model 252 makes use of a machine learning model for every cell that the user visits and forms a prediction. The spatial aware model 252 aims to deduce if the UE experienced any service degradation on a specific serving cell over the investigation window. Hence, the case profile feature matrix input to the ML model 250b is a single block 252a of the target cell labelled “Cell profile” in FIG. 2E. Any suitable ML model may be used to form the spatial aware model 252, including for example, a long short-term memory (LST) model, a one-dimensional convolutional neural network and a Spatio-Temporal Graph Convolutional Neural Networks (ST-GCNN). The ML module 222 then performs the inference for each critical serving cell and aggregates the results using a post-processing logic.

The spatial-temporal aware model 254 subdivides the investigation window into multiple shorter periods (e.g., 24 hours, although any suitable duration may be used) and infers the service degradation type for each cell per interval. Hence, the input case profile feature matrix 254a to the ML model 254b is a smaller matrix that describes the cell and UE performance for each cell and each time period. The outcomes are consolidated after the model inference.

For every UE, a 7-day history of the KPI profile is extracted for the time period prior to the care call time. This is generally sufficient to analyze a vast majority of service issues, including both acute and chronic issues, reported by customers. As described earlier, all KPIs are aggregated using a 15-minute time bin. For the feature channel axis, each “Cell profile” block includes 57 Cell-level features, and 11 UE-level features. Thus, the feature matrix size of each block is 68×1344.

The network data used to troubleshoot UE service issues is formulated as multivariate time-series data in each cell profile block. Thus, the ML module 222 applies the multivariate time-series classifiers to learn the network issue types. Specifically, the ML module 222 uses DNN (deep-neural-network) type models, such as LSTM (Long short-term memory) model, 1D-CNN (1-D convolutional neural network over time channel) model, and ST-GCN (spatial-temporal graph convolutional network) model, to train and validate the learning system.

There are two major reasons for choosing DNN-type models over traditional time-series classifiers (such as Time Series Forest, Random Interval Spectral Ensemble, K-Nearest-Neighbors with Dynamic Time Warping). First, the total volume training data set is large, such as greater than 1 TB. Therefore, training data has to be loaded in batches with global random shuffling. DNN models are better suited for this training scheme. Second, the input feature profiles, which include various cell-level and UE-level features, is highly dimensional. DNN models outperform traditional ones in learning feature representation from such high-dimensional data.

The ML diagnosis model is trained using historical care logs and tickets data. However, the practical care workflow might not always accurately diagnose TAR issues due to limited visibility and challenges and may yield low detection recall. To de-noise the customer care data, the following methods may be used. First, if Tier-2 analysis of a customer care ticket (created by a care agent in response to a customer call) concluded that a site was impacted by a TAR issue, all customer calls associated with that site are labeled as calls impacted by TAR issues. Second, if a ticket was created by a RAN engineering team to fix a RAN configuration or hardware issue in response to a customer impacting issue, care calls associated with the cells in the ticket are identified and those UEs are labeled as impacted by that RAN issue. Third, in cases where a cluster of complaints are identified from an area in a short period, consulted expert operators were consulted to understand the reason of the trending issue and labeled the calls accordingly. In this context, expert operators refer to the Tier-2/Tier-3 network operators who handle trending customer complaints in an area and perform in-depth diagnosis on the network side. Upon receiving a clustered customer complaint incident report, such experts investigate network KPIs, tickets and alarms. If necessary, they also closely work with local vendors/RAN engineers to thoroughly investigate and resolve the issues.

Nevertheless, obtaining accurate “ground truth” service diagnosis result data for individual customer issues is inherently challenging, particularly when the root cause is from the network side and must be addressed offline by network operators. In such scenarios, most users do not fully engage in the entire troubleshooting process or provide feedback regarding changes in their service experience as the network issues are resolved. Hence, it becomes impossible to perform causality analysis between network incidents and individual user service issues for most cases. The data used for training the models is the best available source of human-inferred issue type labels. These labels are primarily derived from correlation analysis between customer care calls and network incidents by the CSP operators.

The parameters of models may be tuned based on the optimal cross-validation classification accuracy given controlled training time. Specifically, the LSTM model has two hidden layers with 64 LSTM kernels each and a softmax classification layer. The 1D-CNN model has three hidden layers with 256 kernels of size 3 and a classification layer. The ST-GCN model follows a recommended configuration, i.e., two ST-ConvBlocks with 32, 16, 8, 4 CNN kernels of size 4 respectively. Deeper neural networks were found to not further improve the accuracy. The ST-GCN model is only applicable to the E2E schema.

FIG. 2F illustrates root cause determination for service issues in a cellular network in accordance with various aspects described herein. The SP/ST-aware model 254 can provide detailed Cell-by-Cell/day-by-day diagnostic results. However, the troubleshooting system workflow that is used by tier-1 customer care agents requires a conclusive inference result that can identify the issue type and determine the appropriate resolution path after the initial diagnosis. Hence, for this use case, the ML module 222 applies heuristics to the outputs of the SP-aware model 252 and the outputs of the ST-aware model 254 to determine a conclusive result. FIG. 2F illustrates aspects of the applied heuristics.

In the example of FIG. 2F, four cells labeled 1 through 4 are evaluated according to the ST-model over the 7 days prior to the time 262 of receipt of the care call from the customer reporting the service issue. ST-model outputs for each of the seven days are illustrated.

For the SP-aware model 252, where an issue type is predicted for each serving cell, the ML module 222 determines a conclusive issue type based on issue prioritization 260. Various issue types are assigned a relative priority, illustrated in the upper portion of FIG. 2F. In the illustrated example, a network outage (O) has a higher priority than acute temporary congestion (ATC); acute temporary congestion has a higher priority than chronic problems (X); chronic problems have a higher priority than coverage issues (C). Any alternative categorization of issues may be used, and any alternative prioritization may be used in other embodiments. Higher priority issues (e.g., network outage) are typically more urgent and have a higher impact on customers. Moreover, higher priority issues are often the root causes of lower-priority issues. For instance, a network outage in one cell might trigger temporary congestion in neighboring cells due to traffic offloading. Such congestion or outage may also lead to coverage issues as the UE being handed-off from its primary cell to a sub-optimal one.

For the ST-aware model 254, the conclusive issue type is determined based on both the issue's occurrence time and priority. This is illustrated in the lower portion of FIG. 2F. If a network issue is detected within the 24 hours preceding the care call (Day 7), the ML module 222 traces back from Day 7 to the first issue occurrence date, e.g., Day 4 shown with the O indicating network outage in FIG. 2F) and checks if the UE experienced any service issues with any candidate cells on consecutive previous days. Along this trace, the ML module 222 selects the highest priority issue as the root cause, as this issue is likely the origin of all subsequent issues in neighboring cells.

The illustrated systems and methods serve to limit the importance of information received directly from the customer, such during the care call with the care agent. Such information can be less than reliable, turning on customer memory and ability to identify and describe symptoms, sometimes days or weeks after a service issue. Instead, the illustrated embodiments operate to infer the cause of user service issues from performance metrics observed from network data. Previous work has used artificial intelligence and machine learning solutions to assist the agent by identifying if the service issue originates on the network side or the device side. In accordance with the embodiments herein, the AI/ML tools assist by identifying an issue category, such as network outage, acute temporary congestion, etc. With this information, the care agent's task of resolving the customer's service issue is greatly simplified.

The ML module 222 prediction runs in real time upon receipt of the care call from the user. Results of the analysis from the ML module 222 are provided to the care agent before they start to speak to the customer to guide the diagnosis process. Unlike current practices, where care agents use customer provided information to troubleshoot service issues, the ML module 222 provides care agents with an ordered list of likely root causes and corresponding resolution actions. This may lead to handling time reduction (HTR) as agents can skip the need for diagnosis. Analysis has shown a handling time reduction on the order of 50%, depending on the model used.

FIG. 2G depicts an illustrative embodiment of a method 270 in accordance with various aspects described herein. The method 270 may form part of a workflow for managing interaction between a user on a cellular network experiencing a service issue and a care agent assigned to handle the user's inquiry. The user may be currently experiencing the issue or may have experienced the issue in the past. The care agent is tasked with assisting the user with the resolution of the service issue, including categorizing the issue as one of a provisioning issue, a network outage, acute temporary congestion in the cellular network, a chronic problem in the cellular network or a coverage issue. The method 270 may be implemented by any suitable processing system including a processor and memory. For example, a network element that is part of a core network of the cellular network may implement the method 270. The method 270 may be initiated upon receipt of the care call from the user to the customer agent. In embodiments comma the steps illustrated in FIG. 2G may be performed prior to connecting the user and the customer agent on the care call.

At step 272, the care call from the user to the cellular network customer care operation is received. Further, in response to receiving the care call, the method includes automatically retrieving customer identification information for the user. In some embodiments, the signaling for the customer care call includes calling line identification (CLID) information for the cellular number assigned to the user. Step 272 may include using the CLID information for retrieving the customer's information.

Step 274 includes determining if the service issue associated with the customer is a provisioning issue. Step 276 includes retrieving provisioning information for the user associated with the customer identification information. Provisioning refers to the features and capabilities designated by the operator of the cellular network for the user device or for the user under a subscription for service between the user and the network operator. Generally, provisioning information is established when the user initiates the subscription with the network operator. If the user adds or removes a service or a feature, the provisioning information may be modified to reflect the change.

At step 278, the method 270 includes determining if there is a mismatch in the provisioning information for the user and in the current provisioning for the user device. If not, processing continues at step 294. If there is a mismatch, or if there is any other issue identified with the provisioning for the user's account or for the user's device, at step 280, the provisioning issue is prioritized and information will be provided to the care agent during the call with the user. In an example embodiment, at step 294, the provisioning for the user device and for the network may be updated to be correct and to match. Any preexisting state information for the UE may be flushed or deleted from components of the network, and the user device may be rebooted to start operation with the correct provisioning information.

If, at step 278, no provisioning mismatch was identified, at step 296, the method includes checking for a transport and RAN (TAR) issue.

If, at step 274, no provisioning issue was determined, at step 282, a series of operations are initiated to categorize the service issue experienced by the customer. In embodiments, the operations of step 282, step 284, step 286, step 288 and step 290 may be performed by a machine learning process. In examples, the machine learning process may be trained using existing, historical customer care data from the customer care operation of the cellular network operator.

At step 282, the method 270 includes identifying critical serving sectors which the user device has attached to in a recent time period. During usage, the user device may attach to or communicate with many cells in the cellular network as the user moves. Each cell site includes multiple sectors, typically 3 sectors. Moreover, if multiple frequencies are supported at a cell site, more sectors may be supported as well. In an example embodiment, network performance data for the cellular network includes a time stamp value measured at each cell visited by the user device and a key performance indicator measurement associated with that time stamp. This data can be aggregated and used to form a trajectory for the user and user device. The trajectory can be established in five-minute bins and used to compute a utilization ratio for each cell. The cells can be ranked by utilization ratio to identify critical serving cells or sectors.

At step 284, the method 270 includes identifying cell level anomalies. Network performance data may be retrieved for the time and location associated with the service issue reported by the customer as well As for the critical serving sectors identified in step 282. Some level anomalies include missing data at a sector, which suggests a service outage at that time, reduced throughput at the sector, abnormal radio resource control data for the sector and spikes in traffic at a sector. These anomalies can be potential indicators of service degradation that impact UEs such as the user device served by the cell.

At step 286, any user device performance degradation corresponding to the reported time for the service outage may be identified. In example embodiments, network performance data for the user device may be retrieved and key performance indicator values reviewed to identify performance degradation.

At step 288, the method 270 includes determining if there is a correlation between the cell level anomalies identified at step 284 and the user device performance degradation identified at step 286. If there is no correlation at step 298, a care ticket may be prepared and submitted to tier 2 investigators for manual troubleshooting and debugging of the problem. If a correlation is identified, at step 290, the service issue outage is classified. As noted, the classification may identify the category for the service issue as one of a provisioning issue, a network outage, acute temporary congestion in the cellular network, a chronic problem in the cellular network or a coverage issue. In other examples, other categories of service issues may be identified.

At step 292, the care call initiated by the user to the customer care operation of the cellular network operator is connected between the user and the care agent assigned to the call. The user and the care agent may begin communicating. As the call is completed, the care agent is advised by the method 270 as to the classification of the service outage.

Thus, the process illustrated in FIG. 2G may be performed in the background, before the call is connected between the user and the care agent, in order to provide the care agent with substantial information about the nature of the call and the nature of the service outage experienced by the user. This can greatly reduce the amount of time required on the call for the care agent to engage with the user and learn the nature of the service outage. Moreover, the network information retrieved and relied on by the method 270 may be more reliable than information recalled and reported and described by the customer. As a result, a care call in accordance with method 270 may be handled more rapidly and more properly and provide a more satisfying result for the user who has experienced the service issue. The process of method 270 can help to reduce queuing time for customers calling for assistance by reducing the duration of the care calls. The process of method 270 can help to reduce the number of repeated calls from the customer regarding the same or similar issue. Further, the process of method 270 can reduce the number of trouble tickets generated by care agents who are unable to identify the service issue, or who incorrectly identify a service issue.

Thus, the method 270 and the ML module 222 of FIG. 2D operate to improve the efficiency of cellular service troubleshooting and resolution process by (i) reducing manual investigation done by care agents in the troubleshooting process, (ii) eliminating the dependency on customers to be able to provide accurate information, (iii) bridging the knowledge gap of correlating user reported issues to network performance data. Embodiments provide a novel ML-based solution which uses a combination of fine grained network usage and event data at user-level coupled with network data at cell level to predict a multi-class label that indicates the causes of user reported issues. Based on this label, the system and method provides recommended resolution to care agents during the troubleshooting process.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

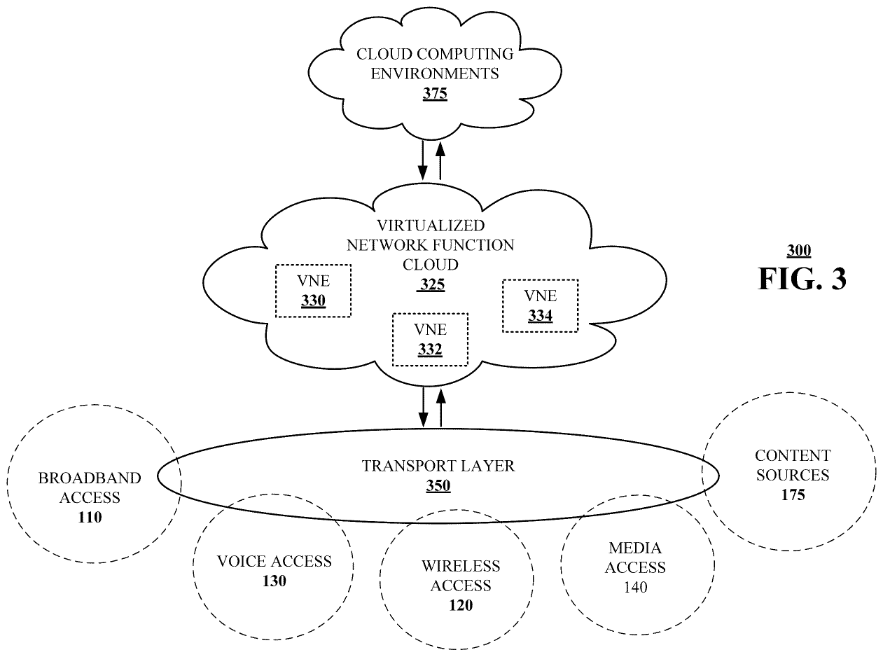

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 270 presented in FIGS. 1, 2A, FIG. 2C, FIG. 2D, FIGS. 2G and 3. For example, virtualized communication network 300 can facilitate in whole or in part retrieving network performance data for troubleshooting a service issue in a network, inferring a category for the root cause of the service issue using a machine learning model or artificial intelligence process, and providing information about the category of the root cause to a customer care agent for resolution of the service issue.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

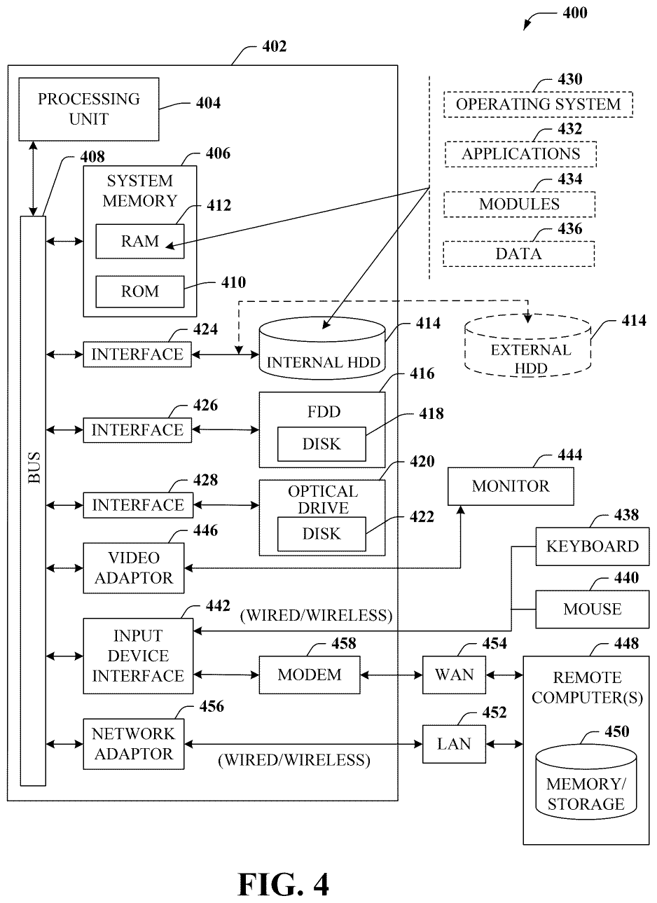

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part retrieving network performance data for troubleshooting a service issue in a network, inferring a category for the root cause of the service issue using a machine learning model or artificial intelligence process, and providing information about the category of the root cause to a customer care agent for resolution of the service issue.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

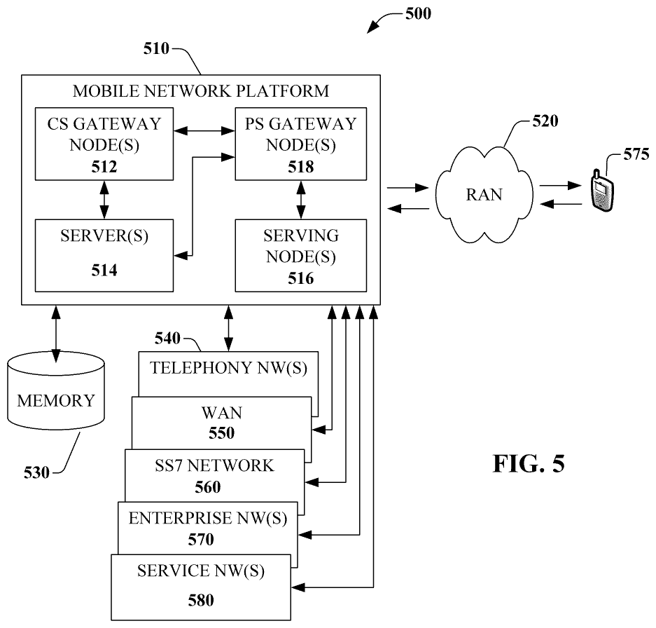

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part retrieving network performance data for troubleshooting a service issue in a network including the platform 510, inferring a category for the root cause of the service issue using a machine learning model or artificial intelligence process, and providing information about the category of the root cause to a customer care agent for resolution of the service issue. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

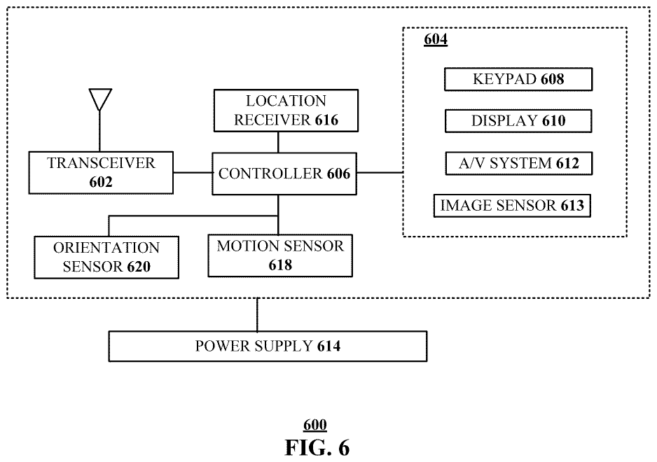

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part retrieving network performance data for troubleshooting a service issue in a network, inferring a category for the root cause of the service issue using a machine learning model or artificial intelligence process, and providing information about the category of the root cause to a customer care agent for resolution of the service issue.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
receiving a care call from a user reporting a service issue in a cellular network, the cellular network including cells for providing communication services to user equipment;
retrieving network performance data based on a user identification of the user;
identifying network performance anomalies based on the network performance data;
identifying service degradation for a user device of the user based on the network performance data;
correlating, in an artificial intelligence/machine learning (AI/ML) process, the network performance anomalies and the service degradation for the user;
identifying a service issue category for the service issue based the AI/ML process; and
reporting the service issue category to a care agent prior to connecting the care call between the user and the care agent.

2. The device of claim 1, wherein the retrieving network performance data comprises:
retrieving user key performance indicator data for the user device; and
retrieving network key performance indicator data for cells of the cellular network.

3. The device of claim 2, wherein the operations further comprise:
identifying critical serving cells of the cells of the cellular network, wherein the critical serving cells includes cells of the cellular network to which the user device of the user attached for a time exceeding a time threshold.

4. The device of claim 3, wherein the identifying critical serving cells of the cellular network comprises:
identifying, based on the network performance data, visited cells of the cellular network, wherein the visited cells include cells of the cellular network to which the user device of the user attached during a predetermined time period;
identifying, based on the network performance data, a utilization ratio for each cell of the visited cells; and
ranking the visited cells based on the utilization ratio.

5. The device of claim 1, wherein the identifying network performance anomalies comprises:
identifying critical serving cells of the cells of the cellular network;
identifying missing data for the critical serving cells among the network performance data;
identifying chronic abnormal data values for the critical serving cells among the network performance data; and
identifying temporary traffic variations for the critical serving cells among the network performance data.

6. The device of claim 5, wherein the retrieving network performance data comprises:
identifying a service outage time corresponding to the service issue; and
retrieving network key performance indicator data for the critical serving cells at the service outage time.

7. The device of claim 1, wherein the identifying the service degradation for the user device of the user comprises:
computing a signal and channel quality value for the user device of the user, wherein the signal and channel quality value is based on the network performance data;
computing a traffic value for the user device of the user, wherein the traffic value is based on the network performance data; and
computing a radio resource control (RRC) message rate for the user device of the user, wherein the RRC message rate is based on the network performance data.

8. The device of claim 1, wherein the operations further comprise:
identifying critical serving cells of the cells of the cellular network;
combining information about the network performance anomalies for the critical serving cells and information about the service degradation for a user device of the user to form a cell profile for each cell of the critical serving cells;
concatenating the cell profile for each cell of the critical serving cells, forming a case profile;
providing the case profile as an input to the AI/ML process; and
identifying a most likely root cause for the service issue based on an output from the AI/ML process.

9. The device of claim 1, wherein the operations further comprise:
identifying critical serving cells of the cells of the cellular network;
combining information about the network performance anomalies for the critical serving cells and information about the service degradation for a user device of the user to form a cell profile for each cell of the critical serving cells;
providing the cell profile for each respective cell of the critical serving cells as respective inputs to the AI/ML process; and
identifying the service issue category for the service issue based on an output from the AI/ML process.

10. The device of claim 1, wherein the operations further comprise:
identifying critical serving cells of the cells of the cellular network;
combining information about the network performance anomalies for the critical serving cells and information about the service degradation for a user device of the user to form a cell profile for each cell of the critical serving cells;
defining analysis time periods for the cell profile, each analysis time period including selected cell profile information for a selected time period;
providing respective cell profile information for each respective cell for respective selected time periods of the critical serving cells as respective inputs to the AI/ML process; and
identifying the service issue category for the service issue based on an output from the AI/ML process.

11. A non-transitory machine-readable medium, comprising executable instructions that, when executed by a processing system including a processor, facilitate performance of operations, the operations comprising:
retrieving network performance data for a cellular network, wherein the retrieving the network performance data is responsive to receipt of user identification of a user associated with a user device, the user device associated with a service issue in the cellular network;
identifying critical serving cells of the cellular network for the user device;
identifying, for the critical serving cells, network performance anomalies, wherein the identifying the network performance anomalies is based on the network performance data;
identifying, for the user device of the user, service degradation, wherein the identifying the service degradation is based on the network performance data;
combining anomaly information based on the network performance anomalies and service degradation information based on the service degradation, forming a cell profile;
providing the cell profile as an input to a machine learning model;
receiving, from the machine learning model, a service issue category for the service issue; and
providing information about an identification of the service issue category to a care agent for resolution of the service issue.

12. The non-transitory machine-readable medium of claim 11, wherein the operations further comprise:
receiving, from the user associated with the user device, a care call regarding the service issue;
determining user identification information for the user based on the care call; and
connecting the care call between the user associated with the user device and the care agent after the providing the information about identification of the service issue category to the care agent.

13. The non-transitory machine-readable medium of claim 11, wherein the identifying network performance anomalies comprises:
identifying missing data for the critical serving cells among the network performance data;
identifying chronic abnormal data values for the critical serving cells among the network performance data; and
identifying temporary traffic variations for the critical serving cells among the network performance data.

14. The non-transitory machine-readable medium of claim 11, wherein the identifying the service degradation comprises:
retrieving user key performance indicator (KPI) data for the user device;
computing, based on the KPI data, a signal and channel quality value for the user device;
computing, based on the KPI data, a traffic value for the user device of the user; and
computing, based on the KPI data, a radio resource control (RRC) message rate for the user device of the user.

15. The non-transitory machine-readable medium of claim 11, wherein the operations further comprise:
retrieving device provisioning information for a subscription for cellular services associated with the user of the user device;
comparing the device provisioning information for the subscription for cellular services and current provisioning of the user device; and
identifying a provisioning issue as the service issue category for the service issue, wherein the identifying is based on the comparing.

16. The non-transitory machine-readable medium of claim 15, wherein the receiving a service issue category for the service issue comprise:
receiving, from the machine learning model, information identifying the service issue as a network outage, acute temporary congestion in the cellular network, a chronic problem in the cellular network or a coverage issue in the cellular network.

17. A method, comprising:
retrieving, by a processing system including a processor, network performance data for a cellular network, wherein the retrieving network performance data comprises retrieving cell key performance indicator (KPI) data for selected cells of the cellular network and user equipment (UE) KPI data for a user device associated with a service issue in the cellular network;
inferring, by a machine learning (ML) model implemented by the processing system, a category for a cause of the service issue, wherein the ML model receives at least a portion of the cell KPI data and the UE KPI data as input; and
providing, by the processing system, information about the category for the cause of the service issue to a service agent for resolution of the service issue.

18. The method of claim 17, comprising:
grouping, by the processing system, portions of the cell KPI data and portions of the UE KPI data to form a cell profile; and
providing the cell profile as an input to the ML model.

19. The method of claim 18, wherein the grouping the portions of the cell KPI data and the portions of the UE KPI data comprises:
grouping, by the processing system, critical serving cell KPI data associated with critical serving cells of the cellular network and the UE KPI data to form the cell profile.

20. The method of claim 18, wherein the grouping the portions of the cell KPI data and the portions of the UE KPI data comprises:
identifying, by the processing system, critical serving cells of the cellular network for the user device;
selecting, by the processing system, a target cell of the critical serving cells of the cellular network; and
grouping, by the processing system, critical serving cell KPI data associated with the target cell and the UE KPI data to form the cell profile.
